(19) United States
(12) Patent Application Publication
(10) Pub. No.: US 2015/0227629 A1
(43) Pub. Date: Aug. 13, 2015

(54) FINANCIAL REPORTING SYSTEM WITH REDUCED DATA REDUNDANCY

(71) Applicant: Christian Klensch, Angelbachtal (DE)

(72) Inventor: Christian Klensch, Angelbachtal (DE)

(21) Appl. No.: 14/179,746

(22) Filed: Feb. 13, 2014

(51) Int. Cl. G06F 17/30; G06Q 40/00

(52) U.S. Cl. CPC G06F 17/30867; G06Q 40/12; G06F 17/30469

(57) ABSTRACT

The present disclosure involves systems, software, and computer-implemented methods for providing a split testing framework. An example method includes identifying a request for a particular financial report of one or more financial reports, each financial report based on financial data stored in a database, and including an execution plan representing how to select the financial data from the database and one or more calculations to be performed on the financial data; and in response to identifying the request for the particular financial report: selecting the financial data for the particular financial report, the selecting performed based at least in part on the execution plan for the particular financial report; performing the one or more calculations associated with the particular financial report on the selected financial data to produce financial report results; and presenting the financial report results.

### BACKGROUND

The present disclosure involves systems, software, and computer-implemented methods for providing a financial reporting system with reduced data redundancy.

Financial systems produce reports based on financial data to provide information on the financial state of an entity associated with the financial data, such as a business or individual. Financial reports may include profitability reports, general payables reports, receivables reports, revenue reports, cost reports, or other types of reports.

### SUMMARY

The present disclosure involves systems, software, and computer-implemented methods for providing a financial reporting system with reduced data redundancy. In one general aspect, an example method includes identifying a request for a particular financial report of one or more financial reports, each financial report based on financial data stored in a database, and including an execution plan representing how to select the financial data from the database and one or more calculations to be performed on the financial data; and in response to identifying the request for the particular financial report: selecting the financial data for the particular financial report, the selecting performed based at least in part on the execution plan for the particular financial report; performing the one or more calculations associated with the particular financial report on the selected financial data to produce financial report results; and presenting the financial report results.

While generally described as computer-implemented software embodied on non-transitory, tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system providing a financial reporting system with reduced data redundancy according to an implementation.

FIG. 2 is a block diagram illustrating an example financial data management system.

FIG. 3 is a block diagram illustrating an example financial data management system according to an implementation.

FIG. 4 is flow chart showing an example method for providing a financial reporting system with reduced data redundancy according to an implementation.

### DETAILED DESCRIPTION

The present disclosure involves systems, software, and computer-implemented methods for providing a financial reporting system with reduced data redundancy.

Generally, storage of financial data within a financial system is performed in ways that introduce data redundancy. For example, aggregated data may be persisted within the system for use in presenting or generating various reports. This introduces data redundancy because both the original financial data and the aggregated data based on that financial data must be stored. Further, different views or reports based on the financial data or the aggregated data may be stored, introducing additional data redundancy. Such redundancy consumes additional resources, as multiple representations of the same data must be maintained and stored.

The present disclosure describes various solutions operable to avoid such data redundancies within a financial system. By utilizing high performance data retrieval capabilities, the financial system can aggregate, transform, and otherwise manipulate the financial data on the fly, such that reports can be generated on-demand in response to requests and need not be pre-generated or stored, thereby reducing data redundancy. One example method includes identifying a request for a particular financial report based on stored financial data. In response to identifying the request, the financial data for the particular financial report is selected, one or more calculations associated with the particular financial report are performed on the selected financial data to produce financial report results, and the financial report results are presented.

Implementations according to the present disclosure may provide several advantages over prior techniques. By reducing the need to store multiple representations of the same data, data redundancy within a financial system can be reduced, leading to decreased storage costs. Further, because the financial system only stored one copy of the financial data, each report generated will represent the most current representation of the financial data, as there is no aggregate data, summary data, or other data to be updated. The process of acquiring new financial data is also simplified, as the data need only be updated in one location with the financial system.

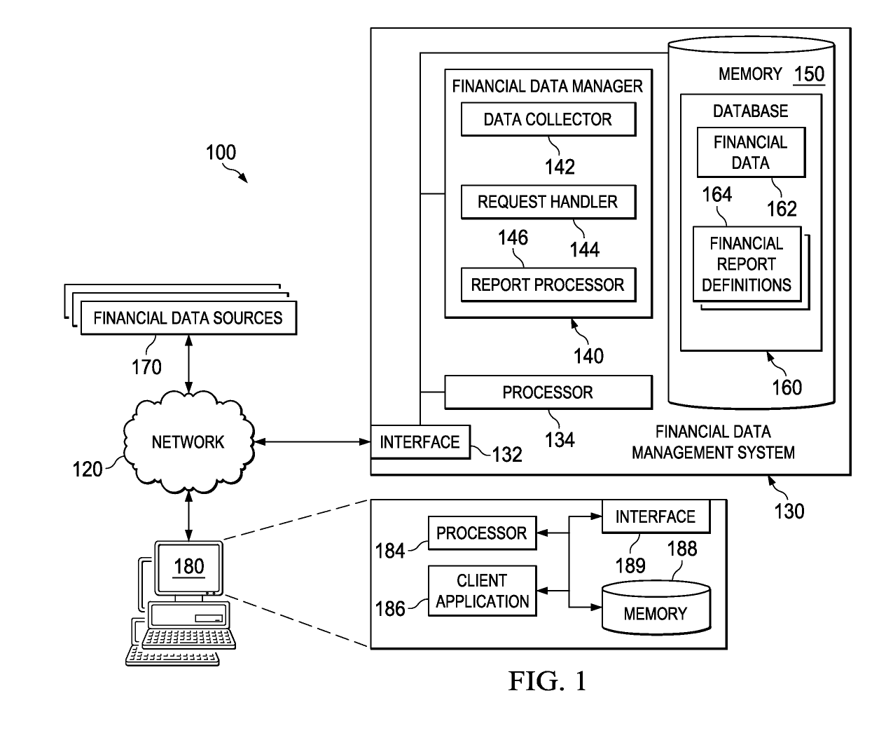

FIG. 1 is a block diagram illustrating an example environment 100 for providing a financial reporting system with reduced data redundancy. As shown, the example environment 100 includes a network 120 connected to a financial data management system 130, one or more clients 180, and one or more financial data sources 170. In operation, the financial data management system 130 receives, retrieves, or otherwise acquires and/or stores financial data 162 from the one or more financial data sources 170, and stores it in the database 160. The financial data management system 130 receives requests from the one or more clients 180 for one or more financial report definitions 164. In response to receiving a request, the financial data management system 130 interacts with the database 160 to generate the requested financial report based on the financial data 162 and the financial report definition 164. Generating the requested financial report may include selecting the financial data 162 associated with the financial report 164, and performing one or more calculations associated with the financial report on the selected data. In some implementations, these steps may be performed concurrently. In addition, in some implementations, the financial data 162 may be organized into a plurality of columns, and data from two or more different columns may be selected concurrently.

The environment 100 includes the financial data management system 130. The financial data management system 130 may be operable to acquire and/or store financial data 162 from or associated with the one or more financial data sources 170, and produce financial reports based on the stored financial data 162 in response to requests received from clients. In some implementations, the financial data management system 130 may be a server or set of servers executing software operable to perform these functions. In some cases, the financial data management system 130 may be a distributed system, with different servers within the distributed system operable to perform one or more of the described functions.

As used in the present disclosure, the term “computer” is intended to encompass any suitable processing device. For example, although FIG. 1 illustrates a financial data management system 130, environment 100 can be implemented using two or more servers, as well as computers other than servers, including a server pool. Indeed, financial data management system 130 may be any computer or processing device such as, for example, a blade server, general-purpose personal computer (PC), MAC, workstation, UNIX-based workstation, or any other suitable device. In other words, the present disclosure contemplates computers other than general purpose computers, as well as computers without conventional operating systems. Further, illustrated financial data management system 130 may be adapted to execute any operating system, including LINUX, UNIX, WINDOWS, MAC OS, JAVA, ANDROID, iOS or any other suitable operating system. According to one implementation, financial data management system 130 may also include or be communicably coupled with an e-mail server, a Web server, a caching server, a streaming data server, and/or other suitable server.

The financial data management system 130 includes an interface 132. The interface 132 is used by the financial data management system 130 for communicating with other systems in a distributed environment—including within the environment 100—connected to the network 120; for example, the clients 180, as well as other systems communicably coupled to the network 120 (not illustrated). Generally, the interface 132 comprises logic encoded in software and/or hardware in a suitable combination and operable to communicate with the network 120. More specifically, the interface 132 may comprise software supporting one or more communication protocols associated with communications such that the network 120 or interface's hardware is operable to communicate physical signals within and outside of the illustrated environment 100.

The financial data management system 130 includes a processor 134. Although illustrated as a single processor 134 in FIG. 1, two or more processors may be used according to particular needs, desires, or particular implementations of environment 100. Each processor 134 may be a central processing unit (CPU), a blade, an application specific integrated circuit (ASIC), a field-programmable gate array (FPGA), or another suitable component. Generally, the processor 134 executes instructions and manipulates data to perform the operations of the financial data management system 130.

The financial data management system 130 also includes a financial data manager 140. In some implementations, the financial data manager 140 is a software program or set of software programs operable to acquire the financial data 162 from the financial data sources 170 and generate financial reports in response to requests received from the clients 180. In some implementations, the financial data manager 140 may include software programs executing on different servers in communication with the database 160 to perform these different functions. In some cases, the different servers may be logically and/or physically different. The financial data manager 140 may also be a software program including different modules associated with these functions.

The financial data manager 140 includes a data collector 142. In operation, the data collector 142 may acquire the financial data 162 from the financial data sources 170 and stored in the database 160. In some implementations, the data collector 142 may periodically request new financial data 162 from each of the financial data sources 170, such as, for example, by sending requests over the network 120 according to an application programming interface (API). The data collector 142 may also receive unsolicited financial data from the financial data sources 170, such as in the form of messages sent over the network 120 by the financial data sources 170 when new financial data 162 is available. In some cases, the data collector 142 may select financial data 162 from databases associated with the financial data sources 170, and insert the selected financial data into the database 160 as financial data 162. The data collector 142 may also receive financial data 162 in batch, such as in the form of files transferred from the one or more financial data sources 170 including transactions for a certain time period. In some implementations, the data collector 142 may acquire the financial data 162 from the financial data sources 170 by using a combination of these and other mechanisms. The data collector 142 may use different mechanisms for acquiring the financial data 162 for different ones of the financial data sources 170. For example, the data collector 142 may be associated with a financial service and be provided access to the financial service's data in order to receive, retrieve, or otherwise acquire the data from the service.

The financial data manager 140 also includes a request handler 144. In operation, the request handler 144 receives requests from the one or more clients 180 to execute financial reports defined by the financial report definitions 164. The request handler 144 may parse such requests to determine the requested financial report, and may interact with another component, such as the report processor 146, to generate the requested financial report and return the results of the report to the requesting client 180. In some implementations, the request handler 144 may receive requests according to a network protocol, such as, for example, Hypertext Transfer Protocol (HTTP), Simple Object Access Protocol (SOAP), Remote Procedure Call (RPC), or other protocols. In some cases, the request handler 144 may receive requests for particular financial reports encoded in Simple Query Language (SQL), as well as any other suitable format.

The financial data manager 140 also includes a report processor 146. In operation, the report processor 146 generates the requested report based on the financial data 162 and the financial report definition 164 corresponding to the requested report. For example, if the financial data management system 130 received a request for a profitability report on financial data 162 for a certain time period, the report processor 146 would select the financial data 162 corresponding to that time period, and perform one or more calculations defined in the financial report definition 164 corresponding to the profitability report. In some implementations, the database 160 may be a columnar database, and the financial data 162 may be arranged into one or more different columns containing different types of data. In such a case, the report processor 146 may select financial data 162 that is stored in different columns of the database 160 in parallel, such as by using multiple threads of execution executing on the processor 134. Further, the report processor 146 may perform the one or more calculations defined by the financial report definition 164 in parallel on the data selected from the different columns, such that, in some cases, the calculations may be performed on portions of the data as they are selected, rather than waiting for the entire data set to be selected.

In some cases, the report processor 146 may execute the report based on an execution plan included in or associated with the financial report definition 164. The report processor 146 may also optimize the execution plan based on one or more directives included in or associated with the financial report definition 164. These and other optimizations may allow for increased data throughput, and may allow the financial reports to be generated on demand in response to the requests in a reasonable amount of time, thereby alleviating the need to have the reports pre-generated and stored in the database 160.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Per10, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The financial data management system 130 also includes a memory 150 or multiple memories 150. The memory 150 may include any type of memory or database module and may take the form of volatile and/or non-volatile memory including, without limitation, magnetic media, optical media, random access memory (RAM), read-only memory (ROM), removable media, or any other suitable local or remote memory component. The memory 150 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the financial data management system 130. Additionally, the memory 150 may include any other appropriate data, such as VPN applications, firmware logs and policies, firewall policies, a security or access log, print or other reporting files, as well as others.

As illustrated in FIG. 1, memory 150 includes or references data and information associated with and/or related to providing the financial reporting system. As illustrated, memory 150 includes a database 160. The database 160 may be one of or a combination of several commercially available database and non-database products. Acceptable products include, but are not limited to, SAP® HANA DB, SAP® MaxDB, Sybase® ASE, Oracle® databases, IBM® Informix® databases, DB2, MySQL, Microsoft SQL Server®, Ingres®, PostgreSQL, Teradata, Amazon SimpleDB, and Microsoft® Excel, as well as other suitable database and non-database products. Further, database 160 may be operable to process queries specified in any structured or other query language such as, for example, Structured Query Language (SQL).

The database 160 includes financial data 162. The financial data 162 is acquired from the financial data sources 170 by the data collector 142 and inserted into the database 160. In some implementations, the financial data 162 may be preprocessed into a coherent format by the data collector 142, such that data from the different financial data sources 170 is converted into a common format for storage in the database 160. The financial data 162 may also be stored in a native or raw format corresponding to the format in which it was acquired from the financial data sources 170 by the data collector 142. In some implementations, the financial data 162 is stored in a single location within the database 160, such that redundant copies of the data, or reports and other information derived from the financial data 162 are not included within the database 160. Such data is instead generated on-the-fly in response to requests and based on the financial data 162.

The database 160 also includes one or more financial report definitions 164. The financial report definitions 164 define the attributes of financial reports can be generated based on the financial data 162 in response to requests from the one or more clients 180. In some cases, the financial report definitions 164 may include one or more calculations to be performed on the financial data 162 to produce the corresponding financial report. For example, a financial report definition 164 for a profitability report might include calculations to calculate total revenue and total cost, and then to subtract total cost from total revenue to determine profitability. In some implementations, the financial report definitions 164 may include instructions to be executed to generate the corresponding financial report. For example, the financial report definitions 164 may include instructions and one or more programming languages, including, but not limited to, SQL, JAVASCRIPT, JAVA, PYTHON, or other programming languages. The financial report definitions 164 may include execution plans instructing the report processor 146 on how to select and process the financial data 162 for the corresponding financial report. The financial report definitions 164 may also include directives, from which the report processor 146 may create an execution plan.

The environment 100 also includes one or more financial data sources 170. In some implementations, the financial data sources 170 may be financial systems tracking different types of financial data, such as, for example, financial accounting data, asset accounting data, special ledger accounting data, management accounting data, inventory data, cost data, revenue data, or other types of financial data. In some cases, the financial data sources 170 may be financial systems within a single enterprise, such as financial systems providing financial data 162 associated with different divisions or departments within the enterprise. The financial data sources may also be sources external to the enterprise, such as banks, vendors, financial institutions, or external sources. As previously described, the financial data sources 170 may provide financial data to the financial data management system 130 by many different mechanisms, including, but not limited to, by responding to requests for specific data, by providing new financial data 162 to the financial data management system 130 when it becomes available, by providing new financial data 162 in batch at the end of a specified time period, or by other mechanisms.

Environment 100 also includes one or more clients 180. Illustrated client 180 is intended to encompass any computing device, such as a desktop computer, laptop/notebook computer, wireless data port, smart phone, personal data assistant (PDA), tablet computing device, one or more processors within these devices, or any other suitable processing device. For example, client 180 may comprise a computer that includes an input device, such as a keypad, touch screen, or other device that can accept user information and an output device that conveys information associated with the operation of the financial data management system 130 or client 180 itself, including digital data, visual information, or a graphical user interface (GUI). Client 180 may include an interface 189, a processor 184, a memory 188 and a client application 186. In some implementations, the client application 186 may be a web browser. Client 180 may be used by a user to access the financial data management system 130 to request execution of a report corresponding to one of the financial report definitions 164 in the database 160. In some implementations, the client application 186 may be an application configured to allow a user to define the financial report definitions 164.

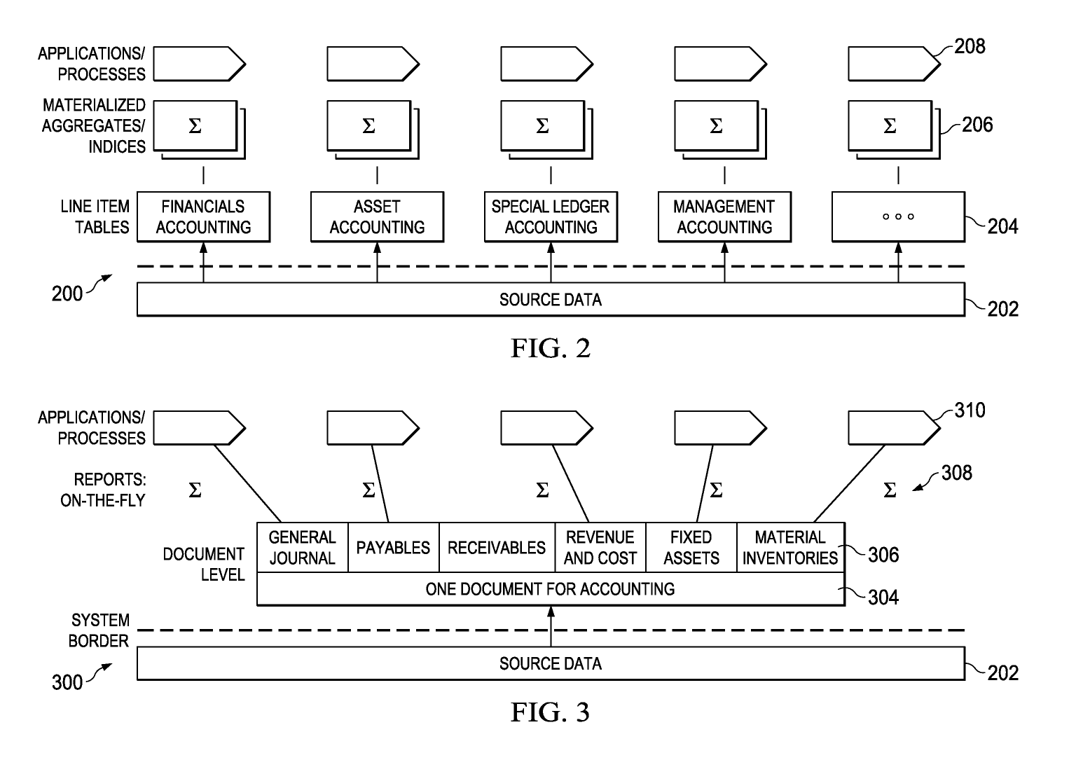

FIG. 2 is a block diagram illustrating an example financial data management system 200 according to previous approaches. As shown, the source data 202 is received by the system and stored in different tables 204 associated with different types of data. For example, the tables 204 include separate tables for financial accounting data, asset accounting data, special ledger accounting data, and management accounting data. One or more views 206 are generated based on the data in the tables 204, and then stored in the system. The one or more views 206 are then selected by one or more applications 208, such as for presentation to users.

FIG. 2 shows that source data may be replicated in two ways. The source data 202 is replicated horizontally, meaning the data from the various financial data source are replicated to several tables according to their respective purpose. The relevant parts of the source data 202 may be transformed and stored in a format specific to the respective purpose. For example, profitability and revenue data may both be derived from the source data 202, and stored in separate tables. Such storage is redundant, since both types of data are derived from the same source data.

The source data 202 is also replicated vertically. Additional tables may be created for access purposes, such as storing aggregated and other views based on the source data 202. These additional data may be generated to serve different purposes, such as data access response time requirements. These additional views may also need to be defined before they are requested, which restricts flexibility as to their structure significantly.

In some cases, the need to replicating data several times leads to subsequent reconciliation tasks. Further, data retrieval flexibility is restricted and data throughput is reduced because various updates may be dependent on each other. The need to store different forms of the source data 202 also increases the amount of data storage necessary, which leads to increased cost.

FIG. 3 is a block diagram illustrating an example financial data management system 300 according to an implementation. As shown, the source data 302 is integrated into a single representation 304 of the data. This is different than the approach illustrated in FIG. 2, where multiple copies of the source data 202 may be stored in different formats corresponding to different purposes. Different reports 306 may be defined based on the store data 304. These reports may contain different calculations 308 based on the stored data 304. Applications 310 may request different reports 306, and the calculations 308 required by the different reports 306 may be performed in response to these requests, and to produce results may be returned to the requesting application 310. In some cases, the reports 306 may contain instructions on how to execute the report, but may not contain any pre-calculated data to be returned when the report executes to avoid unnecessary duplication of data that can be generated on-the-fly.

As previously described, the system 300 shown in FIG. 3 may be operable to avoid data redundancies within a financial system. By utilizing high performance data retrieval capabilities, the financial system 300 can aggregate, transform, and otherwise manipulate the financial data on the fly, such that reports can be generated on-demand in response to requests and need not be pre-generated or stored, thereby reducing data redundancy. For example, the single representation of the data 304 may be a granular representation of the source data 202, such that the reports 306 may be calculated from it. For example, the single representation of the data 304 may be stored in a table or series of tables, and may represent transactions, events, or other granular representations of financial activity from which the reports 305 may be generated.

The system 300 reduces the need to store multiple representations of the same data, thereby reducing data redundancy within the system 300 and lowering storage costs. Further, because system 300 only stores one copy of the financial data, each report generated will represent the most current representation of the financial data, as there is no aggregate data, summary data, or other data to be updated. The process of acquiring new financial data is also simplified, as the data need only be updated in one location with the system 300.

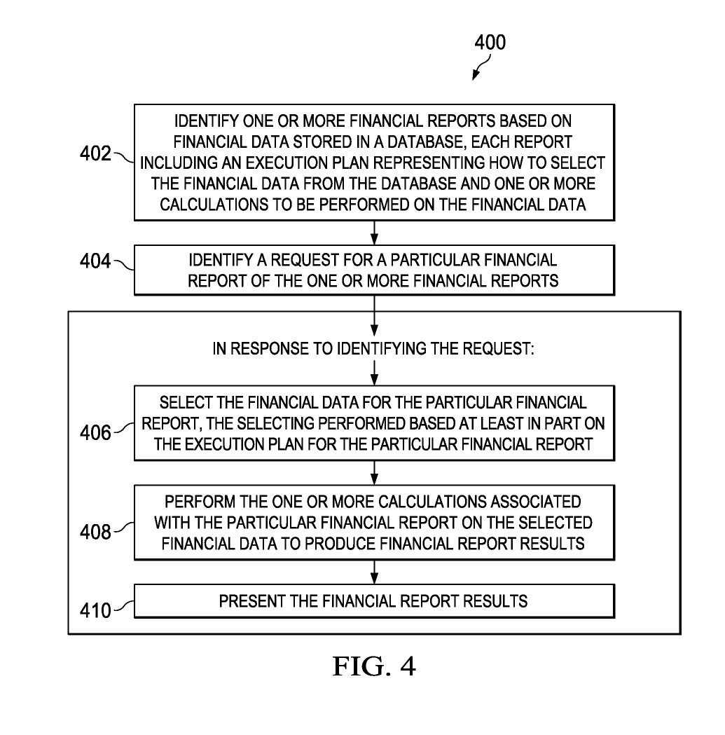

FIG. 4 is flow chart showing an example method 400 for providing a financial reporting system with reduced data redundancy according to an implementation. For clarity of presentation, the description that follows generally describes method 400 in the context of FIGS. 1-3. However, method 400 may be performed, for example, by any other suitable system, environment, software, and hardware, or a combination of systems, environments, software, and hardware, as appropriate. For example, one or more of the financial data management system, the client, or other computing device (not illustrated) can be used to execute method 400 and obtain any data from the memory of the client, navigation management system, or the other computing device (not illustrated).

At 402, one or more financial reports are identified based on financial data stored in a database. Each report may include an execution plan representing how to select the financial data from the database and one or more calculations to be performed on the financial data. In some implementations, the financial data is stored in a single location in the database without redundancy. For example, the financial data may be stored in a single set of tables, with no data duplication, and financial reports may be generated on-the-fly in response to requests based on the financial data. In some implementations, the financial data includes at least one of: financial accounting data, asset accounting data, special ledger accounting data, or management accounting data. the one or more financial reports include at least one of: a general journal report, a payables report, a receivables report, a revenue report, a cost report, a fixed assets report, or a material inventories report. At 404, a request for a particular financial report of the one or more financial reports is identified.

The remaining actions of the method 400 are performed in response to identifying the request at 404. At 406, the financial data for the particular financial report is selected. Selection is performed based at least in part on the execution plan for the particular financial report. In some implementations, the database is a columnar database, the financial data that the particular report is based on is included in a plurality of different columns within the columnar database, and selecting the financial data for the particular financial report includes selecting the data from two or more of the plurality of different columns concurrently.

At 408, the one or more calculations associated with the particular financial report are performed on the selected financial data to produce financial report results. In some implementations, the one or more calculations associated with the particular financial report include a plurality of parallelizable calculations, and wherein performing the one or more calculations includes performing two or more of the parallelizable calculations concurrently. In some cases, performing the one or more calculations associated with the particular financial report on the selected financial data includes performing the one or more calculations concurrently with selecting the financial data by performing the one or more calculations on each portion of the financial data associated with the particular financial report in response to it being selected. At 410, the financial report results are presented. In some cases, the financial report results are not stored in the database.

The preceding figures and accompanying description illustrate example processes and computer implementable techniques. Environment 100 (or its software or other components) contemplates using, implementing, or executing any suitable technique for performing these and other tasks. These processes are for illustration purposes only and that the described or similar techniques may be performed at any appropriate time, including concurrently, individually, or in combination. In addition, many of the steps in these processes may take place simultaneously, concurrently, and/or in different order than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method executed by one or more processors, the method comprising:
identifying a request for a particular financial report of one or more financial reports, each financial report based on financial data stored in a database, and including an execution plan representing how to select the financial data from the database and one or more calculations to be performed on the financial data; and
in response to identifying the request for the particular financial report:
selecting the financial data for the particular financial report, the selecting performed based at least in part on the execution plan for the particular financial report;
performing the one or more calculations associated with the particular financial report on the selected financial data to produce financial report results; and
presenting the financial report results.

2. The method of claim 1, wherein the financial data is stored in a single location in the database without redundancy.

3. The method of claim 1, wherein the financial report results are not stored in the database.

4. The method of claim 1, wherein the one or more calculations associated with the particular financial report include a plurality of parallelizable calculations, and wherein performing the one or more calculations includes performing two or more of the parallelizable calculations concurrently.

5. The method of claim 1, wherein:
the database is a columnar database,
the financial data that the particular report is based on is included in plurality of different columns within the columnar database, and
selecting the financial data for the particular financial report includes selecting the data from two or more of the plurality of different columns concurrently.

6. The method of claim 1, wherein performing the one or more calculations associated with the particular financial report on the selected financial data includes performing the one or more calculations concurrently with selecting the financial data by performing the one or more calculations on each portion of the financial data associated with the particular financial report in response to it being selected.

7. The method of claim 1, wherein the financial data includes at least one of:
financial accounting data, asset accounting data, special ledger accounting data, or management accounting data.

8. The method of claim 1, wherein the one or more financial reports include at least one of: a general journal report, a payables report, a receivables report, a revenue report, a cost report, a fixed assets report, or a material inventories report.

9. A non-transitory, computer-readable medium storing instructions operable when executed to cause at least one processor to perform operations comprising:
identifying a request for a particular financial report of one or more financial reports, each financial report based on financial data stored in a database, and including an execution plan representing how to select the financial data from the database and one or more calculations to be performed on the financial data; and
in response to identifying the request for the particular financial report:
selecting the financial data for the particular financial report, the selecting performed based at least in part on the execution plan for the particular financial report;
performing the one or more calculations associated with the particular financial report on the selected financial data to produce financial report results; and
presenting the financial report results.

10. The computer-readable medium of claim 9, wherein the financial data is stored in a single location in the database without redundancy.

11. The computer-readable medium of claim 9, wherein the financial report results are not stored in the database.

12. The computer-readable medium of claim 9, wherein the one or more calculations associated with the particular financial report include a plurality of parallelizable calculations, and wherein performing the one or more calculations includes performing two or more of the parallelizable calculations concurrently.

13. The computer-readable medium of claim 9, wherein:
the database is a columnar database,
the financial data that the particular report is based on is included in plurality of different columns within the columnar database, and
selecting the financial data for the particular financial report includes selecting the data from two or more of the plurality of different columns concurrently.

14. The computer-readable medium of claim 9, wherein performing the one or more calculations associated with the particular financial report on the selected financial data includes performing the one or more calculations concurrently with selecting the financial data by performing the one or more calculations on each portion of the financial data associated with the particular financial report in response to it being selected.

15. The computer-readable medium of claim 9, wherein the financial data includes at least one of: financial accounting data, asset accounting data, special ledger accounting data, or management accounting data.

16. The computer-readable medium of claim 9, wherein the one or more financial reports include at least one of: a general journal report, a payables report, a receivables report, a revenue report, a cost report, a fixed assets report, or a material inventories report.

17. A system comprising:
memory for storing data; and
one or more processors operable to perform operations comprising:
identifying a request for a particular financial report of one or more financial reports, each financial report based on financial data stored in a single location in a columnar database without redundancy and included in a plurality of different columns within the columnar database, each financial report including an execution plan representing how to select the financial data from the columnar database and one or more calculations to be performed on the financial data; and
in response to identifying the request for the particular financial report:
selecting the financial data for the particular financial report, the selecting performed based at least in part on the execution plan for the particular financial report, and including selecting the data from two or more of the plurality of different columns concurrently;
performing the one or more calculations associated with the particular financial report on the selected financial data to produce financial report results, wherein performing the one or more calculations associated with the particular financial report on the selected financial data includes performing the one or more calculations concurrently with selecting the financial data by performing the one or more calculations on each portion of the financial data associated with the particular financial report in response to it being selected; and
presenting the financial report results, wherein the financial report results are not stored in the database.

18. The system of claim 17, wherein the financial data includes at least one of: financial accounting data, asset accounting data, special ledger accounting data, or management accounting data.

19. The system of claim 17, wherein the one or more financial reports include at least one of: a general journal report, a payables report, a receivables report, a revenue report, a cost report, a fixed assets report, or a material inventories report.

20. The system of claim 17, wherein the one or more calculations associated with the particular financial report include a plurality of parallelizable calculations, and wherein performing the one or more calculations includes performing two or more of the parallelizable calculations concurrently.
